(19) United States
(12) Patent Application Publication
(10) Pub. No.: US 2020/0036137 A1
(43) Pub. Date: Jan. 30, 2020

(54) POWER CONVERTER SUB-MODULE

(71) Applicant: General Electric Technology GmbH, Baden (CH)

(72) Inventor: Rawaa HABEB, Stafford (GB)

(21) Appl. No.: 15/739,246

(22) PCT Filed: Jun. 22, 2016
(86) PCT No.: PCT/EP2016/064456

§ 371 Date: Dec. 22, 2017

(30) Foreign Application Priority Data
Jun. 25, 2015 (GB) 1511223.8

(51) Int. Cl. H01R 13/631; H01R 4/30; H01R 4/56; H01R 13/24; H01R 25/16; H01R 35/00; H01R 43/00; H02M 7/00; H02M 7/483

(52) U.S. Cl. CPC H01R 13/6315; H01R 4/30; H01R 4/56; H01R 13/2407; H01R 25/161; H02M 7/537; H01R 43/00; H02M 7/003; H02M 7/483; H02M 2007/4835; H01R 35/00

(57) ABSTRACT

There is disclosed a sub-module, for a power converter module, the sub-module comprising: a busbar having a busbar terminal; a converter component having a component terminal; and a flexible connector coupled to the busbar terminal and the component terminal to form an electrical connection therebetween, the connector extending along a first axis X between the busbar terminal and the component terminal. The connector is flexible so that there is at least one degree of freedom between the busbar terminal and the component terminal.

### FIELD OF INVENTION

The invention relates to a sub-module for a power converter, in particular, a sub-module for a voltage source converter having a flexible connector between a terminal of the busbar and a terminal of a component of the sub-module, such as a capacitor or Insulated-Gate Bipolar Transistor (IGBT).

### BACKGROUND OF THE INVENTION

HVDC (high-voltage direct current) electrical power transmission uses direct current for the transmission of electrical power. This is an alternative to alternating current electrical power transmission which is more common. There are a number of benefits to using HVDC electrical power transmission. HVDC is particularly useful for power transmission over long distances and/or interconnecting alternating current (AC) networks that operate at different frequencies.

Increasingly, voltage source converters (VSCs) are being proposed for use in HVDC transmission. VSCs use switching elements such as IGBTs that can be controllably turned on and turned off independently of any connected AC system. In one form of VSC, known as a module multilevel converter (MMC), each valve connecting an AC terminal to a DC terminal comprises a series of sub-modules (or cells) connected in series, each sub-module comprising an energy storage element, such as a capacitor, and a switch arrangement that can be controlled so as to either connect the energy storage element in series between the terminals of the sub-module or bypass the energy storage element. The sub-modules of a valve are controlled to connect or bypass their respective energy storage element at different times so as to vary over time the voltage difference across the valve. By using a relatively large number of sub-modules and timing the switching appropriately the valve can synthesise a stepped waveform that approximates to a sine wave and which contains low levels of harmonic distortion. As will be understood by one skilled in the art there are various designs of MMC. For example, an MMC may be a half-bridge MMC or a full-bridge MMC. In a half-bridge MMC the energy storage element of a sub-module is connected with a half-bridge switch arrangement, which allows the energy storage element to be bypassed or connected to provide a voltage of a given polarity at the terminals of the sub-module. In a full-bridge MMC the energy storage element of a sub-module is connected with a full-bridge switch arrangement, which allows the energy storage element to be bypassed or connected to provide a voltage of either polarity at the terminals of the sub-module.

A previously-considered sub-module comprises a laminated busbar having at least a positive plate, a negative plate and an AC (alternating current) plate. An energy storage element in the form of a capacitor is connected to a terminal on the busbar, and two switching elements such as IGBTs are coupled to terminals on the busbar in a half-bridge arrangement. A busbar is used owing to the high current load through the sub-module, which may be up to 2000 A (Ampere), and is laminated to minimize inductance.

The connectors between the terminals of the busbar and the corresponding terminals of the capacitor and IGBT provide both an electrical and rigid supporting connection.

However, as the power rating of new HVDC VSCs increases, the equipment is placed under increasing electrical loading. The high electrical loading can lead to high thermal loading in the busbar, capacitor, IGBTs and the connectors between them. For example, the busbar may reach up to 100° C. during operation. Further, as the current loading differs between terminals depending on the configuration and operation of the sub-module, the thermal loading may be different from one terminal to another. This thermal loading can impart stress into the components and connections in the sub-module owing to thermal expansion, which may damage sensitive components within the capacitor and/or IGBT, which are generally commissioned as commercial, off-the-shelf items (COTS) (i.e. which may not be specifically designed for an HVDC VSC).

Further, such thermal loading may add to existing stresses imparted in the components and connections in the sub-module owing to tolerance mis-match and/or accumulation associated with the location and sizing of the various terminals, which can lead to damage of the terminals and/or internal components within the converter components (i.e. components within the IGBT or the capacitor). For example, minor mis-alignment between individual connections between components within prescribed tolerances may sum (or “stack-up”) over multiple connections in an assembled sub-module so that there is a greater cumulative mis-alignment between two terminals that are to be connected. In particular, such mis-alignments or offsets may stack-up or sum over connections between a capacitor and busbar, a busbar and IGBT, and between an IGBT and a cooling plate.

### BRIEF DESCRIPTION OF THE INVENTION

Accordingly, it is desirable to provide an improved sub-module.

According to an aspect of the invention there is provided a sub-module for a power converter module, the sub-module comprising: a busbar having a busbar terminal; a converter component having a component terminal; and a flexible connector coupled to the busbar terminal and the component terminal to form an electrical connection therebetween, the connector extending along a first axis between the busbar terminal and the component terminal; wherein the connector is flexible so that there is at least one degree of freedom between the busbar terminal and the component terminal.

The connector may provide a supporting connection between the busbar terminal and the component terminal, such that the converter component is mounted on the busbar by the flexible connector. The converter component may be supported by the or each flexible connector only (i.e. supported by the connectors alone). In other words, the converter component may not be supported by any other elements of the sub-module except for the or each flexible connector.

The converter component may be a switching element or an energy storage element. For example, the converter component may be an Insulated-Gate Bipolar Transistor (IGBT) or a capacitor.

The connector may be extendible and compressible along the first axis so that there is at least an axial degree of freedom along the first axis between the busbar terminal and the component.

The connector may have a stiffness along the first axis of 10⁵ N/m or less. The connector may be configured to be more flexible than the mechanical load path through the respective component. For example, the stiffness along the first axis may be 50% or less, 20% or less or 10% or less of the respective axial stiffness for the mechanical load path through the associated component, for example, the mechanical load path through the internal circuitry of the component coupled to the component terminal.

The connector may be configured to bend about at least a second axis so that there are at least three degrees of freedom between the busbar terminal and the component terminal. The connector may be configured to bend about the second axis so that there is an axial degree of freedom along the first axis, an axial degree of freedom along a third axis orthogonal to the first and second axes, and an angular degree of freedom about the second axis between the busbar terminal and the component terminal. The second axis may be orthogonal to the first axis.

The connector is configured to bend about two axes so that there are at least five degrees of freedom between the busbar terminal and the component terminal. The two axes may be second and third axes which are orthogonal with respect to each other and/or with respect to the first axis.

The connector may be configured to bend about the second axis and the third axis so that there are axial degrees of freedom along the first, second and third axes respectively, and angular degrees of freedom about the second and third axes between the busbar terminal and the component terminal.

The flexural rigidity of the connector about second and third orthogonal axes orthogonal to the first axis may be less than the respective flexural rigidity of the mechanical load path through the associated component. For example, the flexural rigidity may be 50% or less, 20% or less or 10% or less of the respective flexural rigidity for the associated component.

The connector may be configured to twist about the first axis so that there is an angular degree of freedom about the first axis between the busbar terminal and the component terminal. The torsional rigidity of the connector about the first axis may be less than the respective torsional rigidity of the mechanical load path through the associated component. For example, the torsional rigidity may be 50% or less, 20% or less or 10% or less of the respective torsional rigidity for the associated component.

The flexible connector may be in the form of a bellows. The bellows may be substantially axisymmetric. The bellows may be hollow. The bellows may have a flexible portion formed of a single piece of material. The flexible portion may have a corrugated profile.

The flexible connector may be in the form of a spring. The spring may be a helical spring. The spring may be hollow.

The connector may be hollow. In other words, the connector may have an opening extending along the first axis along the length of a flexible portion of the connector, for example, along the full length of the flexible portion of the connector.

The flexible connector may have opposing end attachment portions for coupling with the component terminal and busbar terminal respectively. The component terminal may be threadedly assembled with a corresponding end attachment portion of the connector. The component terminal may comprise a female threaded hole and the corresponding end attachment portion of the connector may comprises a male threaded projection.

The busbar terminal may be coupled to a corresponding end attachment portion of the connector by a bolt or screw inserted through the busbar to engage the respective end attachment portion. The busbar terminal may have a busbar opening for coupling with the connector, and the or each connector may have a radial extent with respect to the first axis which is greater than the radial extent of the busbar opening. The busbar opening may be defined by a bushing inserted into a larger opening in the busbar.

The connector may comprise an auxiliary electrical pathway for conduction between the busbar terminal and the component terminal, and the auxiliary electrical pathway may comprise a flexible wire. The auxiliary electrical pathway may be coupled to opposing end attachment portions of the connector on opposite sides of a flexible portion of the connector. Alternatively, the auxiliary electrical pathway may be coupled directly to the busbar terminal and/or the component terminal. The auxiliary electrical pathway may comprise a liquid metal conductor.

The converter component may be a switching element comprising a casing, and the component terminal may be at least partly disposed outside of the casing.

The converter component may be a switching element, and the switching element may be supported only by the or each flexible connector. The sub-module may comprise one or more cooling elements, each cooling element being mounted on one or more switching elements. The or each cooling elements may be supported only by virtue of being mounted on the one or more switching elements.

The connector may be one of a plurality of connectors extending between respective busbar terminals and respective component terminals of the converter component. The converter component may be one of a plurality of converter components, each converter component having at least one component terminal coupled to a respective busbar terminal by a respective flexible connector.

Each flexible connector may have any of the features of the connector defined with respect to the first aspect of the invention.

There may be at least three converter components including at least two switching elements and an energy storage element. Each switching element may have at least four component terminals coupled to respective busbar terminals by respective flexible connectors, and the energy storage element may have a component terminal coupled to a respective busbar terminal by a respective flexible connector. Each switching element may have six component terminals coupled to respective busbar terminals by respective flexible connectors. There may be four switching elements coupled to the busbar.

According to a second aspect of the invention there is provided a module for a voltage source converter, comprising: a plurality of sub-modules, each in accordance with the first aspect of the invention, arranged in series.

According to a third aspect of the invention there is provided a voltage source converter, such as an AC-DC or DC-AC voltage source converter comprising one or more modules, such as six modules, each in accordance with the second aspect of the invention.

According to a fourth aspect of the invention there is provided a flexible connector for a sub-module in accordance with the first aspect of the invention.

According to a fifth aspect of the invention there is provided a method of connecting a converter component to a busbar using a flexible connector to form a sub-module in accordance with the first aspect of the invention, the method comprising: threadedly assembling a first end attachment portion of the connector with a component terminal of the converter component; inserting a bolt or nut through a busbar terminal of the busbar to threadedly engage a second end attachment portion of the connector, thereby coupling the second end attachment portion of the connector with the busbar terminal.

### BRIEF DESCRIPTION OF THE DRAWINGS

The invention will now be described, by way of example, with reference to the accompanying drawings, in which:

FIG. 1 schematically shows a perspective view of a sub-module for a power converter;

FIG. 2 schematically shows a cross-sectional plan view of a sub-module for a power converter;

FIG. 3 schematically shows a cross-sectional plan view of a sub-module for a power converter;

FIG. 4 schematically shows a cross-sectional view of a connector for the sub-module of FIG. 3;

FIG. 5 schematically shows a cross-sectional view of a further connector for the sub-module of FIG. 3;

FIG. 6 schematically shows a cross-sectional view of a further connector for the sub-module of FIG. 3.

### DETAILED DESCRIPTION OF THE INVENTION

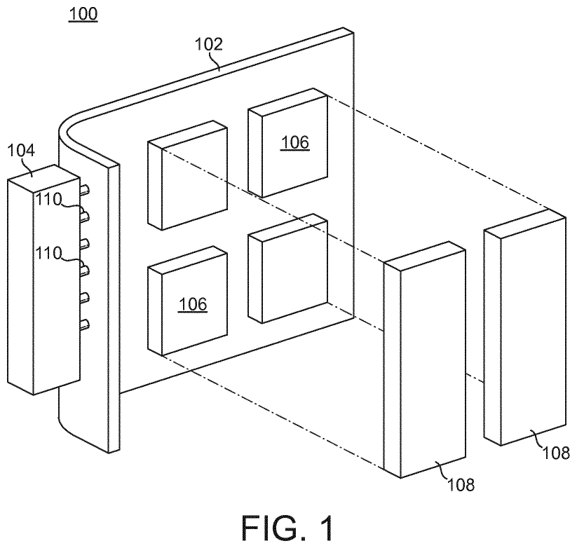

As shown in FIG. 1, a previously-considered sub-module 100 generally comprises a laminated busbar 102, a capacitor 104, four switching elements in the form of Insulated-Gate Bipolar Transistors 106 (IGBTs) and two cooling plates 108 (shown in exploded view, separated from the IGBTs). The laminated busbar 102 provides a low-inductance current path between the energy storage element and the switching elements.

In the assembled sub-module 100, terminals 110 of the capacitor 104 extend into and through corresponding terminals of the busbar 102 and are rigidly secured with a fastening nut (not shown) on the obverse side of the busbar 102, as is conventionally known.

The four IGBTs 106 each have six terminals coupled to corresponding terminals of the busbar 102 with threaded nut fasteners, as described below.

Two cooling plates 108 are fastened to respective pairs of the IGBTs for cooling the IGBTs in operation, for example, by bolts. The cooling plates are liquid-cooled, as is known in the art.

In use, the sub-module 100 is operated by a gate controller (not shown) which controls the switching on and off of each IGBT 106 to determine the voltage difference over the busbar 102 and current drawn from the capacitor 104.

The sub-module 100 is oriented so that the main portion of the bus-bar 102 to which the IGBTs 106 are attached lies in a vertical plane.

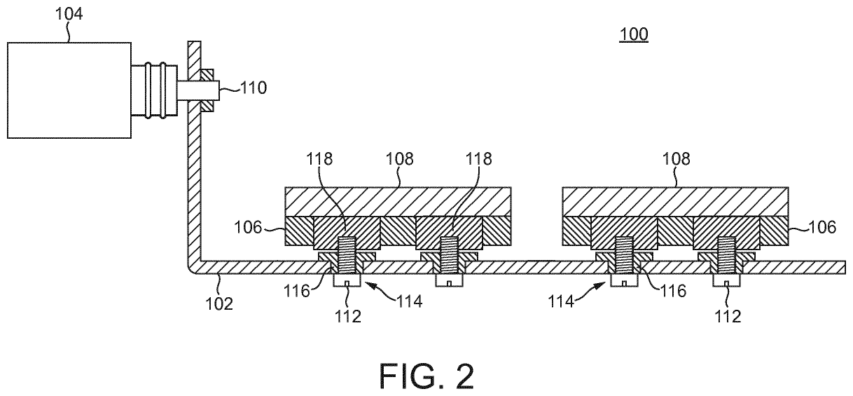

As shown in FIG. 2, the cooling plates 108 are directly mounted to the IGBTs (for example, by bolts), and there is a rigid structural and electrical connection between the busbar 102 and the IGBTs 106 provided by the connector screws 112. There are six busbar terminals 114 provided in the busbar 102 for each IGBT 106, each terminal 114 comprising an opening in the busbar 102 formed in the respective plate or plates of the busbar, and a bushing 116 inserted into the opening. Each bushing 116 is in electrical contact with the respective plate of the busbar 102, and provides an internal cylindrical surface for receiving the connector screw 112 and making electrical contact therewith. Each connector screw 112 is inserted through the respective bushing 116 and into a threaded terminal 118 of the IGBT 106.

During assembly, the IGBT 106 is drawn closer to the busbar as the connector screw 112 is threadedly fitted into the terminal 118 of the IGBT 106, until the respective terminal 118 of the IGBT 106 comes to rest on the outer surface of the bushing 116 (thereby making a supporting and further electrical contact, in addition to electrical conduction through the screw).

As will be appreciated by a person skilled in the art, this arrangement requires careful gradual turning of each of the six connector screws associated with each IGBT 106 during assembly, so that the internal components of the IGBT 106 are not stressed by unequal deflection of one or more terminals 118 owing to unequal tightening. Further, as the busbar 102 is generally very stiff, any over-tightening of a connector screw 112 can cause the terminal 118 of the IGBT or a connected internal component of the IGBT to become damaged, as these will yield in preference to the busbar 102 or bushing 116.

Further, a pair of terminals for mutual connection may become mis-aligned owing to tolerance stack-up in the sub-module, such that a connector screw 112 must be forced into place thereby imparting stress on the associated component (e.g. imparting stress into the IGBT 106).

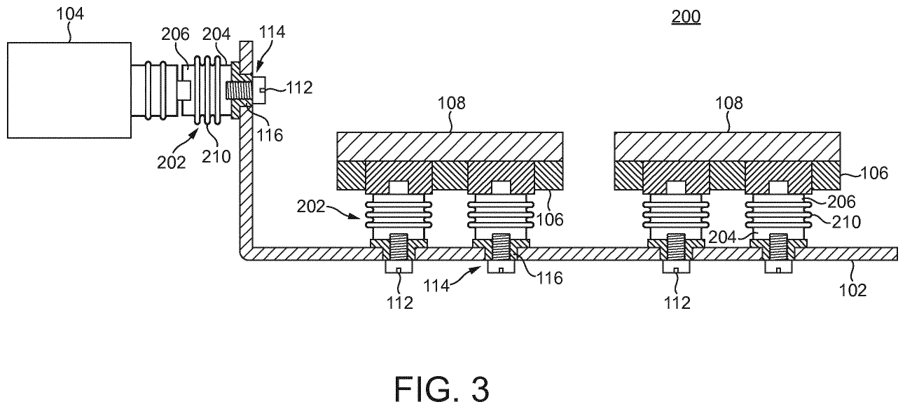

As shown in FIG. 3, a sub-module 200 according to an embodiment of the invention comprises a busbar 102, capacitor 104, four IGBTs 106 (two shown in cross-section) and two cooling plates 108 which are substantially the same as in the sub-module 100 of FIGS. 1 and 2 above.

Further, the sub-module 200 comprises a plurality of flexible connectors 202 extending from each busbar terminal 114 to each of the capacitor terminals 110 and IGBT terminals 118 (referred to herein as component terminals).

In this embodiment, each flexible connector 202 comprises a hollow flexible bellows that extends along a first axis X of the connector 202 from a busbar end portion 204 to a component end portion 206. In this embodiment, the bellows is formed of a unitary piece of copper, but in other embodiments other materials may be used, such as a beryllium-copper alloy. The portion 210 between the busbar end portion 204 and the component end portion 206 is flexible by virtue of the bellows shape including a plurality of concertinaed folds in the wall of the connector. The average cross-sectional area (of conductive material) of the bellows in the flexible portion 210 is 50 mm² in this embodiment, but in other embodiments the cross-sectional area may be lower or higher, for example 20 mm² or 200 mm². The bellows has an outside diameter of 25 mm, and a wall thickness of approximately 0.6 mm. The length along the first axis of the connector 202 is approximately 10 mm.

The busbar end portion 204 is in the form of a disc having a centrally positioned threaded hole configured to receive the connector screw 112. In this embodiment the connector screw has a diameter of 8 mm (also known as “M8”).

The component end portion 206 is in the form of a disc having either a centrally positioned threaded hole for receiving a threaded terminal (such as the terminal 110 of the capacitor 104), or a centrally positioned threaded projection for insertion into a threaded terminal (such as the terminals 118 of the IGBTs 106. As shown in FIG. 3, the component end portions 206 of the connectors 202 for the capacitor 104 have a threaded hole for receiving the threaded terminal 110 of the capacitor 104, whereas the component end portions 206 of the connectors 202 for the capacitor have a threaded projection for insertion into the threaded terminal 118 of the IGBTs. The end portions 204, 206 are approximately 3 mm in length along the first axis and 16 mm in diameter.

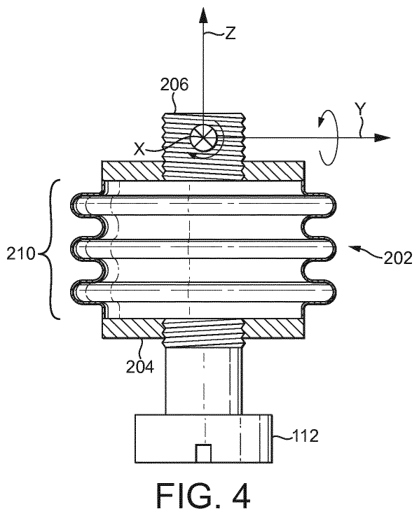

In this embodiment, the flexible portion 210 of the connector is configured for axial compression and extension along a first axis of the connector extending from the busbar end portion 204 to the component end portion 206. The flexible portion 210 is also configured to bend about second and third axes Y, Z which are mutually orthogonal and orthogonal with the first axis. Accordingly, the flexible connector provides five degrees of freedom between the busbar terminal 114 and the component terminal 118, as shown schematically FIG. 4. In particular, there are three axial (or translational) degrees of freedom along the three respective axes (indicated by axes X, Y and Z), and two bending degrees of freedom (or angular degrees of freedom) about the axes Y and Z. In this embodiment, the bellows is stiff in torsion, so that there is no twisting degree of freedom about the X axis.

The flexible portion 210 is configured to have a suitable stiffness along the first axis to accommodate up to 1 mm of extension or compression under normal assembly and operational loading. In other embodiments, the stiffness may be suitable for accommodating up to 2 mm of extension or compression. The stiffness along the first axis is less than the respective axial stiffness of the corresponding mechanical load path in the associated component, such that during assembly and operation, stresses in the sub-module arising from the interconnections or other loads are reacted by elastic deformation (i.e. strain) of the connector 202, as opposed to yielding of the internal circuitry of the associated component (e.g. the IGBT 106).

Further, the flexible portion 210 is configured to have a suitable bending stiffness about the second and third axis to accommodate up to 1 mm of lateral deflection of the component end portion 206 with respect to the busbar end portion 204 owing to bending about the respective axis under normal assembly and operational loading. In other embodiments, the bending stiffness may be suitable for accommodating up to 2 mm. Again, the flexural rigidity (bending stiffness) about each axis is less than the respective flexural rigidity of the mechanical load path of the associated component.

To assemble the sub-module 200, the flexible connectors 202 are connected to the respective components by relative rotation between the component end portion 206 and the associated component terminal. In particular, six connectors 202 are threaded onto the six capacitor terminals 110 so that the externally-threaded capacitor terminals 110 are received in respective internally-threaded openings of the end portions 206 of the respective flexible connectors. Further, six connectors 202 for each IGBT are threadedly assembled with the respective IGBT 106 so that the externally-threaded projection at the component end portions 206 are received in the internally-threaded terminals 118 of the IGBTs 106.

Subsequently, the components (i.e. the capacitor and IGBTs) are held in place against the busbar 102 so that the connectors 202 align with the respective busbar terminals 114, and each connector screw 112 is inserted from the obverse side of the busbar (i.e. the side opposing the respective component) and threaded through the busbar terminal 114 into the threaded hole in the busbar end portion 204 of the connector 202.

Since each connector 202 is flexible, the busbar can be coupled to the capacitor 104 and IGBTs 106 without requiring carefully-coordinated or simultaneous tightening of the connector screws. Further, since the connectors 202 are flexible, and in particular are more flexible than the mechanical load path through the respective components 104, 106, any stress imparted on the connection between the busbar and the respective component is absorbed by deflection of the connector 202, rather than strain on the internal circuitry of the respective component 104, 106.

In this particular embodiment, the axial stiffness (or spring constant) of each connector 202 along its first axis is approximately 10⁵ N/m, whereas the spring constants for the respective mechanical load path through the IGBT 106 and capacitor 104 are substantially greater. For example, the spring constant for the mechanical load path through the IGBT 106 and/or the capacitor 104 may be equal to or greater than 10⁶ N/m.

Further, in this particular embodiment, the flexural rigidity (or bending stiffness, which is equivalent to the product of the Young's Modulus E and second moment of area I; EI) for bending about each of the second and third axes is approximately 50 Nm². This corresponds to lateral deflection of the component terminal with respect to the busbar terminal by less than 1 mm in response to a 100N lateral load at the component terminal. The respective flexural rigidity of the mechanical load path of the component may be significantly greater, such as 100 Nm² or more, or 200 Nm² or more.

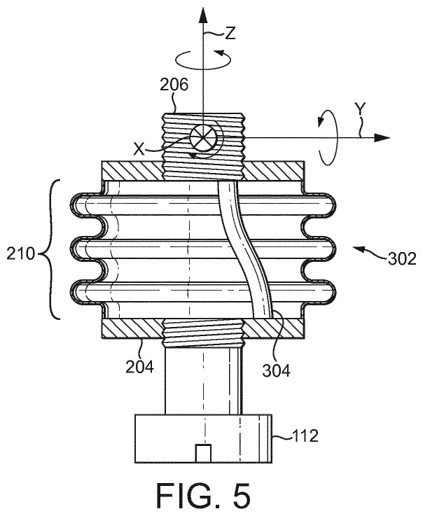

FIG. 5 shows a further embodiment of a connector 302 which differs from the first embodiment (the connector 202) in that an auxiliary electrical pathway is provided that extends through the hollow centre of the connector. In particular, the auxiliary electrical pathway comprises a flexible cable 304 coupled to the busbar end portions 204, 206 so as to serve as a conductor when the connector 302 extends between a busbar terminal 114 and a component terminal 110, 118. In this particular embodiment, the flexible cable 304 is an insulated cable having a liquid metal core, as disclosed in “Self-Healing Stretchable Wires for Reconfigurable Circuit Wiring and 3D Microfluidics”, Palleau et al, Advanced Materials Volume 25, Issue 11 (pages 1589-1592). In this example, the cable 304 is 5 mm in diameter and is flexible so as to provide six degrees of freedom between the two ends. The cable 304 is more flexible than the flexible portion 210 of the bellows/connector with respect to each shared degree of freedom, such that the flexibility characteristics of the connector 302 as a whole are substantially determined by the flexible portion 210 of the bellows alone, and such that the components 104, 106, in particular the IGBTs 106, are supported by the bellows portion of the connector. For example, the axial stiffness along the first axis may be 10⁵ N/m or less, and the flexural rigidity may be 50 Nm² or less.

In other embodiments, the flexible cable 304 may comprise a flexible multi-strand braided wire, for example, a copper wire.

The flexible cable 304 is provided to increase the current carrying capacity of the connector 304 with respect to the first embodiment of the connector 202. The skilled person will appreciate that, in other embodiments, the flexible cable 304 may be provided so that the cross-sectional area of at least the flexible portion 210 of the connector 302 can be reduced so as to increase flexibility (i.e. reduce flexural rigidity). For example, a connector 302 according to this second embodiment may have a flexible bellows portion 210 having an outside diameter of 25 mm, and an average cross-sectional area of conductive material of approximately 20 mm² (corresponding to a wall thickness of approximately 0.25 mm). The flexible cable 304 may have a conductive diameter of approximately 6 mm. The average cross-sectional area of conductive material along the connector 302, including both the bellows and the flexible cable may therefore be approximately 50 mm², which is substantially equivalent to that of the example connector 202 of the first embodiment. The bellows may have an inside diameter of 15 mm.

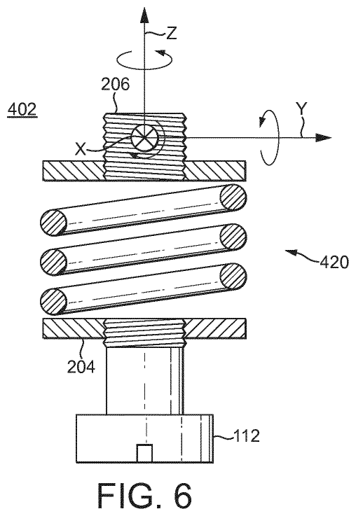

A third embodiment of a connector 402 according to an embodiment shown in cross-section in FIG. 6. The connector 402 differs from the connectors 202 of the first embodiment only in that the flexible portion 420 of the connector 402 is in the form of a hollow helical spring rather than a flexible bellows. The flexible spring portion 420 provides the connector 402 with the same five degrees of freedom as described above with respect to the first embodiment of the connector 202, and in addition can be deflected in torsion (i.e. twisted) so as to provide a sixth angular degree of freedom between the two end portions 204, 206 (i.e. the end portions 204, 206 can twist with respect to each other).

The connector 402 is configured to have a torsional rigidity to allow up to 5° of angular twist between the end portions 204, 206 under normal loads experienced during assembly and operation of the sub-module.

In this embodiment, the helical flexible portion 420 has approximately three revolutions of the helix with an opening extending along the first axis for the length of the flexible portion 420, such that the connector 402 is hollow. The diameter of the helical flexible portion 420 is approximately 16 mm and the length along the first axis is approximately 10 mm. The diameter of the material forming the helix is approximately 3 mm.

It will be appreciated by the person skilled in the art that the bellows and helical spring connectors are examples of flexible connectors that may be provided to allow a flexible connection between the busbar and a component. In other embodiments, different flexible connectors may be provided.

It will be appreciated that the sub-module 200 can be used with flexible connectors 202, 302, 402 from any embodiment described above.

However, connectors such as the bellows-type and helical spring-type connectors are preferred in an embodiment as their configuration allows for the stiffness, flexural rigidity and torsional rigidity characteristics to be configured appropriately. For example, flexural rigidity depends on the second moment of area (I), which is a function of geometry, in particular the amount of material disposed away from the centreline of curvature. Further, torsional rigidity depends on the torsion constant (J), which is similar to the second moment of area and also dependent on geometry. In contrast, a braided wire is generally of uniform cross-section and only the diameter can be controlled to influence stiffness and rigidity characteristics.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What we claim is:

1. A sub-module for a power converter module, the sub-module comprising:
a busbar having a busbar terminal;
a converter component having a component terminal; and
a flexible connector coupled to the busbar terminal and the component terminal to form an electrical connection therebetween, the connector extending along a first axis between the busbar terminal and the component terminal;
wherein the connector is flexible so that there is at least one degree of freedom between the busbar terminal and the component terminal.

2. The sub-module according to claim 1, wherein the converter component is a switching element or an energy storage element.

3. The sub-module according to claim 1, wherein the connector is extendible and compressible along the first axis so that there is at least an axial degree of freedom along the first axis between the busbar terminal and the component.

4. The sub-module according to claim 3, wherein the connector has a stiffness along the first axis of 105 N/m or less.

5. The sub-module according to claim 1, wherein the connector is configured to bend about at least a second axis so that there are at least three degrees of freedom between the busbar terminal and the component terminal.

6. The sub-module according to claim 1, wherein the connector is configured to bend about two axes so that there are at least five degrees of freedom between the busbar terminal and the component terminal.

7. The sub-module according to claim 1, wherein the connector is configured to twist about the first axis so that there is an angular degree of freedom about the first axis between the busbar terminal and the component terminal.

8. The sub-module according to claim 1, wherein the flexible connector is in the form of a bellows.

9. The sub-module according to claim 1, wherein the flexible connector is in the form of a spring.

10. The sub-module according to claim 1, wherein the connector is hollow.

11. The sub-module according to claim 1, wherein the flexible connector has opposing end attachment portions for coupling with the component terminal and busbar terminal respectively.

12. The sub-module according to claim 11, wherein the component terminal is threadedly assembled with a corresponding end attachment portion of the connector.

13. The sub-module according to claim 11, wherein the busbar terminal is coupled to a corresponding end attachment portion of the connector by a bolt or screw inserted through the busbar to engage the respective end attachment portion.

14. The sub-module according to claim 1, wherein the busbar terminal has a busbar opening for coupling with the connector, and wherein the or each connector has a radial extent with respect to the first axis which is greater than the radial extent of the busbar opening.

15. The sub-module according to claim 1, wherein the connector comprises an auxiliary electrical pathway for conduction between the busbar terminal and the component terminal, the auxiliary electrical pathway comprising a flexible wire.

16. The sub-module according to claim 15, wherein the auxiliary electrical pathway is coupled to opposing end attachment portions of the connector on opposite sides of a flexible portion of the connector.

17. The sub-module according to claim 1, wherein the converter component is a switching element comprising a casing, and wherein the component terminal is at least partly disposed outside of the casing.

18. The sub-module according to claim 1, wherein the converter component is a switching element, and wherein the switching element is supported only by the or each flexible connector.

19. The sub-module according to claim 1, wherein the connector is one of a plurality of connectors extending between respective busbar terminals and respective component terminals of the converter component.

20. The sub-module according to claim 1, wherein the converter component is one of a plurality of converter components, each converter component having at least one component terminal coupled to a respective busbar terminal by a respective flexible connector.

21. The sub-module according to claim 19, wherein there are at least three converter components including at least two switching elements and an energy storage element, wherein each switching element has at least four component terminals coupled to respective busbar terminals by respective flexible connectors, and wherein the energy storage element has a component terminal coupled to a respective busbar terminal by a respective flexible connector.

22. A module for a voltage source converter, comprising: a plurality of sub-modules, each in accordance with claim 1, arranged in series.

23. A voltage source converter, such as an AC-DC or DC-AC voltage source converter comprising one or more modules, such as six modules, each in accordance with claim 22.

24. A flexible connector for a sub-module in accordance with claim 1.

25. A method of connecting a converter component to a busbar using a flexible connector to form a sub-module in accordance with claim 1, the method comprising:
threadedly assembling a first end attachment portion of the connector with a component terminal of the converter component;
inserting a bolt or nut through a busbar terminal of the busbar to threadedly engage a second end attachment portion of the connector, thereby coupling the second end attachment portion of the connector with the busbar terminal.
